(19) United States
(12) Patent Application Publication
(10) Pub. No.: US 2007/0211223 A1
(43) Pub. Date: Sep. 13, 2007

(54) System and method for projection systems using sequential color techniques

(75) Inventors: Gregory S. Pettitt, Farmersville, TX (US); Thomas Jay Doty, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incroporated

(21) Appl. No.: 11/370,317

(22) Filed: Mar. 8, 2006

(51) Int. Cl. G03B 21/14

(52) U.S. Cl. 353/84; 353/121

(57) ABSTRACT

A projection system using a sequential color filter is provided. The sequential color filter utilizes red, green, and blue segments with an additional segment that allows brighter yellows and higher color temperatures to be formed efficiently. In an embodiment the additional segment comprises a mixed-transmission level region that partially blocks some of the green and red wavelengths. In another embodiment, an additional segment comprises a notch filter that allows shorter and longer wavelengths to pass, but blocks at least some of the intermediate wavelengths. In other embodiments, other segments, such as a white segment, a yellow segment, a cyan segment, a magenta segment, shades thereof, combinations thereof, and/or the like may be added.

### TECHNICAL FIELD

The present invention relates generally to projection systems and, more particularly, to projection systems using sequential color techniques.

### BACKGROUND

Many projection systems, such as digital light projectors (DLPs), utilize a white light and a sequential color filter to produce different colors. The sequential color filter, such as a color filter wheel, typically includes segments for each of the primary colors red, blue, and green, and spins at a predetermined rate as the white light is projected onto the color filter wheel. As the white light passes through the various segments of the color filter wheel, only certain wavelengths are allowed to pass, thereby producing colored lights corresponding to the colors of the color filter wheel. An integrator receives the colored light and projects the colored light toward a viewing surface. Lenses and/or mirrors may be added as necessary to focus the light.

When the distinct colors of the color filter wheel are projected onto the viewing surface at a fast rate, the human eye integrates the colors to form other colors, such as combining blue and red to form purple. Various colors and shades may be formed by altering the amount of light (length of time) each color is projected.

A typical color wheel contained red, blue, and green segments, as well as a white segment that increases the brightness. In these systems, yellow colors were created by combining the red and green color segments. The yellow colors obtained in this manner, however, were “dingy” yellows. To improve the yellow colors and the brightness of the yellows, color filter wheels having a yellow segment in addition to the red, blue, green, and white segments were used. The yellow segments allowed better yellow colors to be obtained, but lowered the color temperature.

Therefore, there is a need for a sequential color filter that improves, among other things, the yellow colors and the color temperature.

### SUMMARY OF THE INVENTION

These and other problems are generally reduced, solved or circumvented, and technical advantages are generally achieved, by embodiments of the present invention, which provides a system and method for projection systems using sequential color techniques.

In an embodiment of the present invention, a method of forming an image is provided. The method includes transmitting a light beam through a color filter wheel, wherein the color filter wheel includes red, blue, and green segments in addition to a fourth segment. The fourth segment comprises a color filter that allows at least some of the wavelengths corresponding to the shorter wavelengths of visible light and at least some of the wavelengths corresponding to the longer wavelengths of visible light to pass. In an embodiment, the fourth segment comprises a mixed-transmission level filter segment that allows some wavelengths to pass and partially blocks other wavelengths. In another embodiment, the fourth segment comprises a notch filter that allows shorter and longer wavelengths of visible light to pass while at least partially blocking some mid-range wavelengths of visible light. In other embodiments, the color filter wheel may comprise other segments, such as one or more segments of yellow, cyan, magenta, clear, combinations thereof, and/or the like.

In another embodiment of the present invention, a projection system is provided. The projection system comprises a light configured to emit a beam of light toward a color filter wheel, wherein the color filter wheel includes red, blue, and green segments in addition to a mixed-transmission level filter. The mixed-transmission level filter comprises a first region that allows corresponding wavelengths to pass and a second region that allows wavelengths to pass at a lower transmission level. In other embodiments, the color filter wheel may comprise other segments, such as one or more segments of yellow, cyan, magenta, clear, combinations thereof, and/or the like.

In yet another embodiment of the present invention, another projection system is provided. In this embodiment, the projection system comprises a light configured to emit a beam of light toward a color filter wheel having a notch filter. The notch filter allows light corresponding to shorter wavelengths of visible light and longer wavelengths of visible light to pass while at least partially blocking some mid-range wavelengths of visible light.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a system diagram of a projection system utilizing sequential color techniques in accordance with an embodiment of the present invention;

FIG. 2a is a plan view of a color filter wheel in accordance with an embodiment of the present invention;

FIG. 2b is a response graph for the color filter wheel illustrated in FIG. 2a in accordance with an embodiment of the present invention;

FIG. 2c is a chromaticity graph corresponding to the color filter wheel illustrated in FIG. 2a in accordance with an embodiment of the present invention;

FIG. 2d is a graph illustrating effects of various filter offsets in accordance with an embodiment of the present invention;

FIG. 3a is a plan view of another color filter wheel in accordance with an embodiment of the present invention;

FIG. 3b is a response graph for the color filter wheel illustrated in FIG. 3a in accordance with an embodiment of the present invention;

FIG. 3c is a chromaticity graph corresponding to the color filter wheel illustrated in FIG. 3a in accordance with an embodiment of the present invention;

FIG. 4a is a plan view of yet another color filter wheel in accordance with an embodiment of the present invention;

FIG. 4b is a response graph for the color filter wheel illustrated in FIG. 4a in accordance with an embodiment of the present invention; and

FIG. 4c is a chromaticity graph corresponding to the color filter wheel illustrated in FIG. 4a in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

It should be noted that the present invention is described herein with respect to particular embodiments for illustrative purposes only. In particular, the embodiments described herein comprise a color filter wheel as a sequential color filter and are discussed with respect to specific sizes and arrangements of the various color segments. Furthermore, a system in which the color filter wheel may be used is provided for illustrative purposes only. Accordingly, other types of systems, arrangements of colors, sizes of colors, shapes of the sequential color filter, and the like may be used in accordance with other embodiments of the present invention.

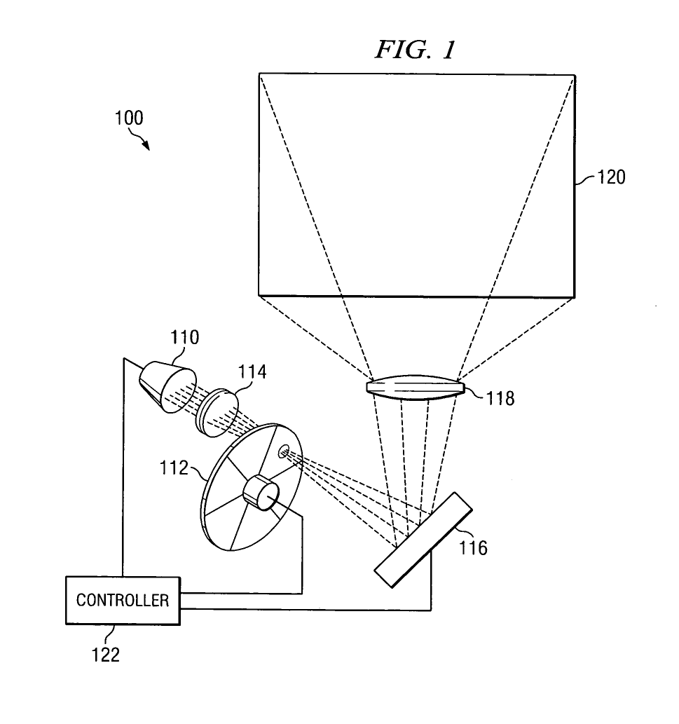

Referring first to FIG. 1, a projection system 100 in accordance with an embodiment of the present invention is illustrated. The projection system 100 comprises a light source 110, such as a lamp, positioned such that light emitted from the light source 110 is directed to a sequential color filter 112. One or more lenses, such as lens 114, may be positioned between the light source 110 and the sequential color filter 112 to aid in focusing the light emitted from the light source 110 on the sequential color filter 112.

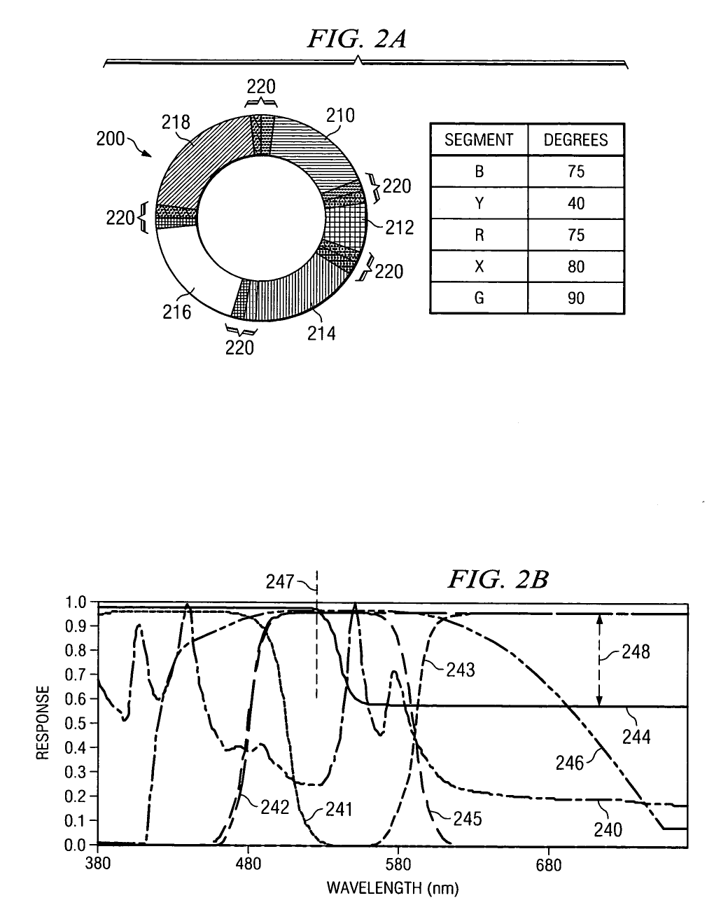

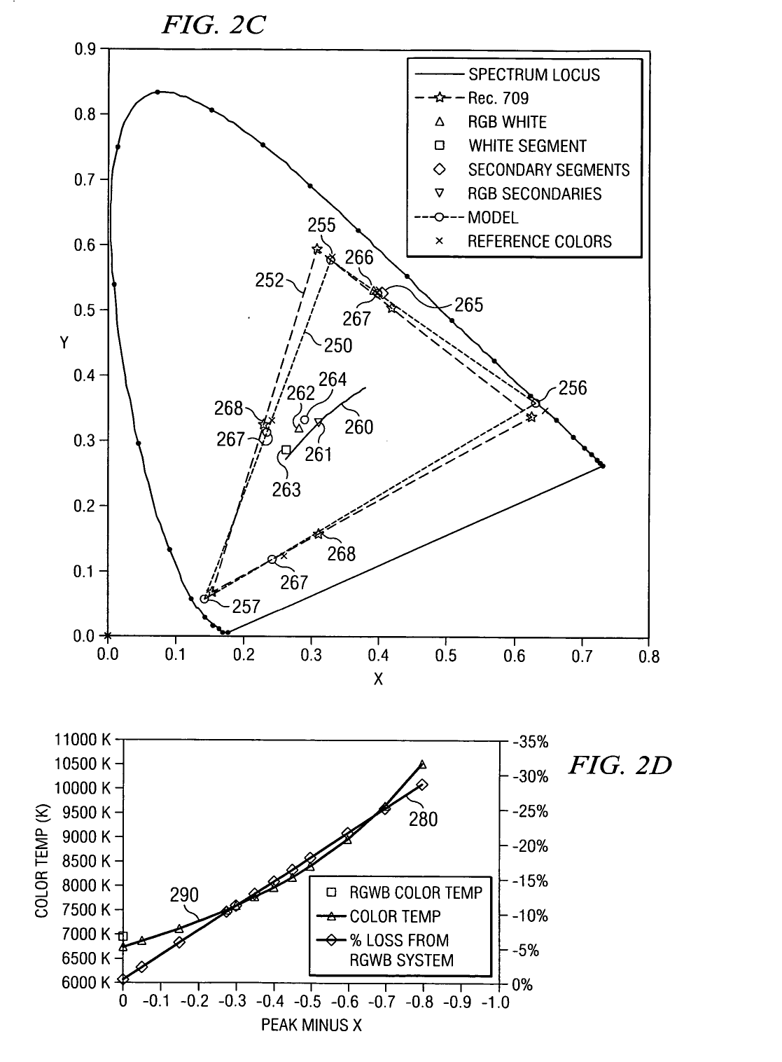

In an embodiment, the sequential color filter 112 is a color filter wheel having red, blue, and green segments arranged in a circular manner. By combining light of these three primary colors, other colors may be created. Some color filter wheels may have other colors, including white (or clear) segments that may be used to increase the brightness. Exemplary color filter wheels that may be used in accordance with embodiments of the present invention are discussed in greater detail below with reference to FIGS. 2a-4c.

A light modulator 116 directs the light from the light source 110 to one or more lenses, such as lens 118, which projects the image onto a viewing surface 120. One example of a suitable light modulator 116 is a digital micromirror device (DMD) produced by Texas Instruments, Inc., of Dallas, Tex. Other components, however, may be used. The projection system 100 may also include a controller 122 communicatively coupled to one or more of the devices, such as the light source 110, sequential color filter 112, and light modulator 116 as illustrated in FIG. 1. The controller 122 may also be communicatively coupled to other devices, such as one or more lenses.

In operation, light (e.g., white light) is emitted from the light source 110 through the lens 114 toward the sequential color filter 112. In embodiments in which the sequential color filter 112 is a color filter wheel, the color filter wheel rotates, thereby passing colored light corresponding to the colors of the sequential color filter 112 onto the light modulator 116. The light modulator 116, controlled by the controller 122, modulates the colored light signal onto the lens 118 and the viewing surface 120. By combining the different colored lights in a specific manner, different colors may be formed on the viewing surface 120.

It should be noted that the projection system 100 is provided as an illustrative embodiment of the present invention only and is not meant to limit other embodiments of the invention. Not all components of a projection system have been shown, but rather the elements necessary for one of ordinary skill in the art to understand concepts of the present invention are illustrated. For example, the projection system may include additional optical devices (e.g., mirrors, lenses, etc.), additional electronics (e.g., power supplies, sensors, etc.), light sinks, and the like. Furthermore, one of ordinary skill in the art will realize that numerous modifications may be made to the projection system 100 within the scope of the present invention. For example, while the sequential color filter 112 is portrayed as a transmissive filter, an embodiment of the present invention may utilize a reflective filter.

FIG. 2a is a plan view of a color filter wheel 200 in accordance with an embodiment of the present invention. As an initial matter, it should be noted that the embodiment discussed herein utilizes a color filter wheel (such as the color filter wheel 200 of FIG. 2) as the sequential color filter 112 of FIG. 1 for illustrative purposes only. In other embodiments, the sequential color filter 112 may be a rotating or stationary polygon, linear shape, or the like.

The color filter wheel 200 comprises a blue segment 210, a yellow segment 212, a red segment 214, a mixed-transmission level segment 216, and a green segment 218. It should be noted that the color filter wheel 200 illustrates a preferred embodiment comprising a yellow segment, but that other embodiments may not utilize a yellow segment and/or comprise additional segments, such as zero or more of each of a cyan segment, a magenta segment, a white segment, shades thereof, combinations thereof, and/or the like.

As illustrated in FIG. 2a, in an embodiment the blue segment 210 is about 75°, the yellow segment 212 is about 40°, the red segment 214 is about 75°, the mixed-transmission level segment 216 is about 80°, and the green segment 218 is about 90°. Generally, the mixed-transmission level segment 216 comprises a filter region that allows different proportions of respective wavelengths to pass. The mixed-transmission level segment 216 is discussed in greater detail below with reference to FIG. 2b.

Spoke regions 220 are positioned between each of the color segments. Generally, the spoke regions 220 represent regions in which the light will not be a single color, but rather will be blended with light from adjacent segments due to the size of the light beam. For example, as the color filter wheel 200 is rotated such that a light beam (not shown) intersects the color filter wheel 200 at a predetermined point, when the center of the light beam crosses the edge of the spoke region 220 between the blue segment 210 and the yellow segment 212, the resulting light will be a combination of blue and yellow. The resulting light will remain a combination of blue and yellow until the center of the light beam crosses the next sequential edge of the spoke region 220 between the blue segment 210 and the yellow segment 212.

FIG. 2b illustrates the response for each color segment of the color filter wheel 200 illustrated in FIG. 2a for the various wavelengths in accordance with an embodiment of the present invention. Line 240 represents the spectral response of a light source. One skilled in the art will realize that different light sources will generate different spectral responses and that different light sources may be selected to suit a particular need, and embodiments of the present invention may be used with light sources having different spectral responses. Lines 241-245 represent the spectral responses for the segments 210-218, respectively, and line 246 represents spectral response of the optics, such as lenses, mirrors, and the like.

As illustrated in FIG. 2b, line 244 corresponding to the mixed-transmission level segment 216 has a first region that substantially allows the respective wavelengths to pass and a second region (a partial transmission region) that reduces the transmission of the respective wavelengths. The point at which the partial-transmission level region begins is referred to as the partial cut-off value and the amount of each wavelength that is blocked is referred to as the reduction offset. The reduction offset, indicated by reference numeral 248, and the partial cut-off value, indicated by reference number 247, may be adjusted to obtain the desired color temperature and minimize the loss of light for a particular application. In the embodiment illustrated in FIG. 2b the mixed-transmission level segment line 244 has a partial cut-off value at about 530 nm at which point the response is reduced to about 60% for the remaining wavelengths. The effects of the reduction offset 248 are further described below with reference to FIG. 2d.

FIG. 2c is a chromaticity graph corresponding to the color filter wheel 200 of FIG. 2a. Color gamut 250 is the color gamut corresponding to the color filter wheel 200 illustrated in FIG. 2a, and color gamut 252 is the color gamut as defined by ITU's Recommendation 709, which is provided for reference. Generally, the color gamut 250 represents the range of colors that may be obtained by, for example, the light projection system 100 as illustrated in FIG. 1 using the color filter wheel 200 illustrated in FIG. 2a, whereas vertices 255, 256, and 257 represent the colors green, red, and blue, respectively.

Line 260 is the approximation of white light emitted by the sun, referred to as the de-illuminate line. The portion of the line 260 to the left are the bluish whites, and the portion of the line 260 to the right are the reddish/yellowish whites. Point 261 represents the white light produced by color gamut 252 and is approximately 6500° K. Generally, however, it is desirable and preferred to have a higher color temperature.

Points 262-264 represent the white lights that may be generated using color gamut 250. Point 262 represents the white light that may be generated using the blue segment 210, the red segment 214, and the green segment 218 of the color filter wheel 200 illustrated in FIG. 2a. Point 263 represents the white light that may be generated through the mixed-transmission level segment 216. Point 264, referred to as the full-on white, represents the white light that may be obtained by combining all of the segments of the color filter wheel 200, including the blue segment 210, the yellow segment 212, the red segment 214, the green segment 218, and the mixed-transmission level segment 216.

Also illustrated in FIG. 2c, are points 265 and 266. Point 265 represents the secondary color yellow that may be generated using the yellow segment 212 of the color filter wheel 200, and point 266 represents the secondary color yellow that may be generated using the blue segment 210, the red segment 214, and the green segment 218. For reference, points 267 represent the secondary colors yellow, cyan, and magenta that may be obtained using the color filter wheel 200, and points 268 represent the secondary colors of ITU's Recommendation 709.

As illustrated in FIG. 2c, the color filter wheel 200 illustrated in FIG. 2a is capable of producing whites having a higher color temperature, which has been found to be more desirable and pleasing to the human eye.

FIG. 2d is a graph illustrating the effects of various reduction offsets that may be used to form the mixed-transmission level segment 216 in accordance with an embodiment of the present invention. Line 280 represents the percentage loss of light for a white color, wherein the percentage of loss is indicated along the right vertical axis of the graph. Line 290 represents the color temperature for a given amount of reduction offsets, wherein the color temperature is indicated along the left vertical axis of the graph. As can be seen in FIG. 2d, as the amount of reduction offset increases, the color temperature increases, but more light is lost and the white line becomes dimmer.

By adding the mixed-transmission level segment 216, brighter yellows may be obtained while retaining higher color temperatures. As noted above, previous systems using a white segment and a yellow segment lowered the color temperature. The mixed-transmission level segment 216 increases the color temperature while allowing brighter yellows to be obtained.

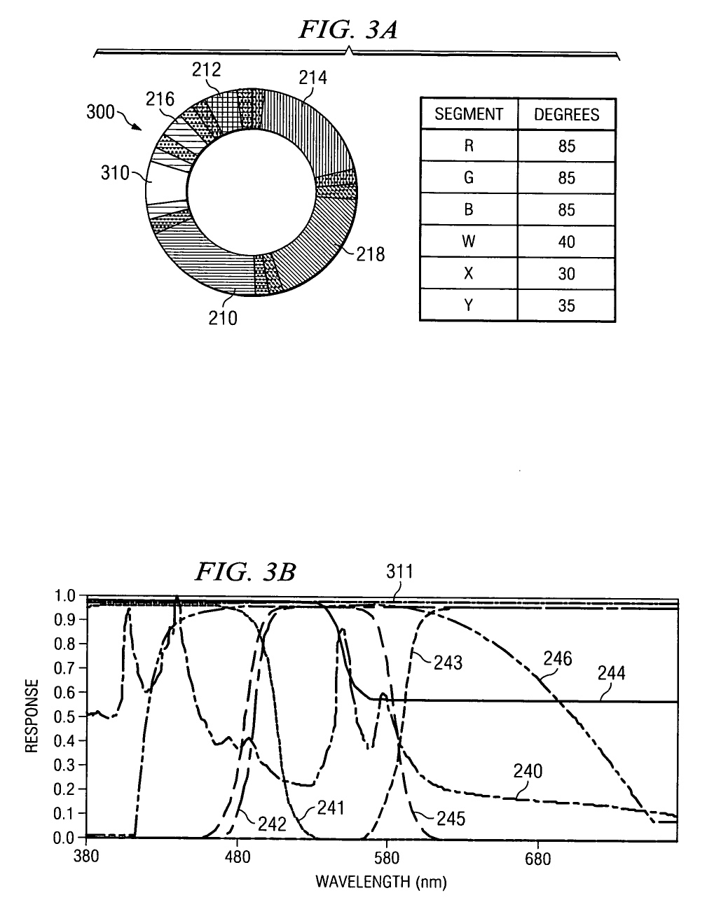

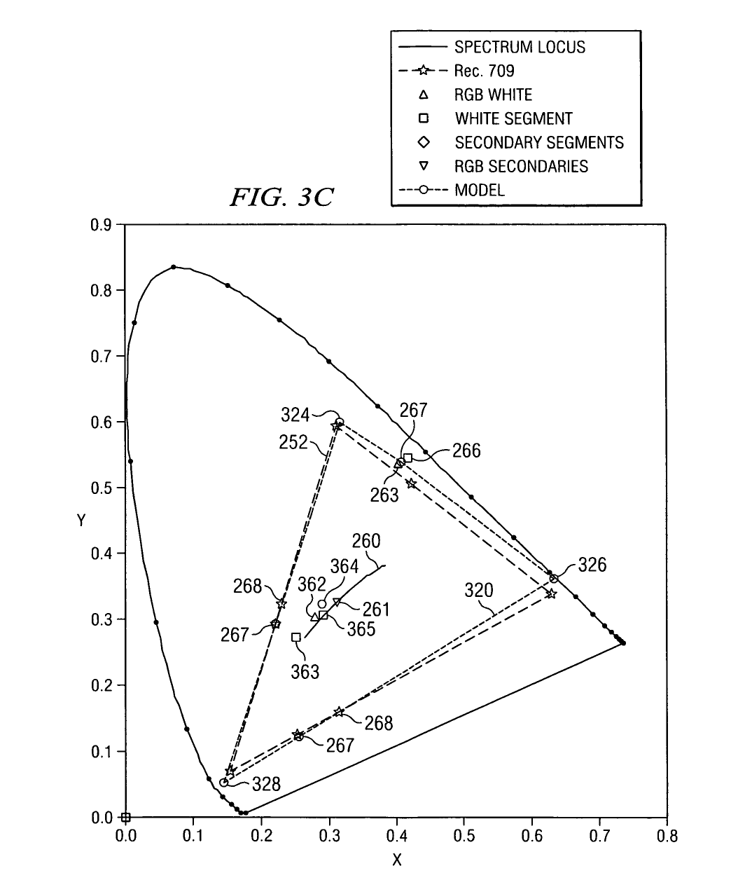

FIG. 3a is a plan view of another color filter wheel 300 in accordance with an embodiment of the present invention. Color filter wheel 300 is similar to the color filter wheel 200 illustrated in FIG. 2a wherein like reference numerals refer to like elements, except that a white segment 310 has been added. However, it should be noted while similar reference numerals may be used for similar color segments, the size of each color segment may be different. In this embodiment the blue segment 210 is about 85°, the yellow segment 212 is about 35°, the red segment 214 is about 85°, the mixed-transmission level segment 216 is about 30°, the green segment 218 is about 85°, and the white segment 310 is about 40°. Other sizes and configurations may be used. In particular, it should be noted that the color filter wheel 300 illustrates a preferred embodiment comprising a yellow segment, but that other embodiments may not utilize a yellow segment and/or comprise additional segments, such as zero or more of each of a cyan segment, a magenta segment, a white segment, shades thereof, combinations thereof, and/or the like.

FIG. 3b illustrates the response for each color segment of the color filter wheel 300 illustrated in FIG. 3a in accordance with an embodiment of the present invention. FIG. 3b is similar to the response graph illustrated in FIG. 2b, except that the white segment 310 allows all wavelengths to pass as illustrated by line 311.

FIG. 3c is a chromaticity graph corresponding to the color filter wheel 300 of FIG. 3a in accordance with an embodiment of the present invention. The chromaticity graph illustrates a color gamut 320 and a color gamut 252. The color gamut 252 represents the color gamut from ITU's Recommendation 709 as discussed above with reference to FIG. 2c. The color gamut 320 represents the colors that may be obtained using the color filter wheel 300, whereas vertices 324, 326, and 328 represent the colors green, red, and blue, respectively. Point 362 represents the white light that may be obtained by combining the blue segment 210, the red segment 214, and the green segment 218. Point 363 represents the white light that may be obtained by using the white segment 310. Point 364 represents the white light and may be obtained by using all segments of the color filter wheel 300, and point 365 represents the white light that may be obtained by using the mixed-transmission level segment 216.

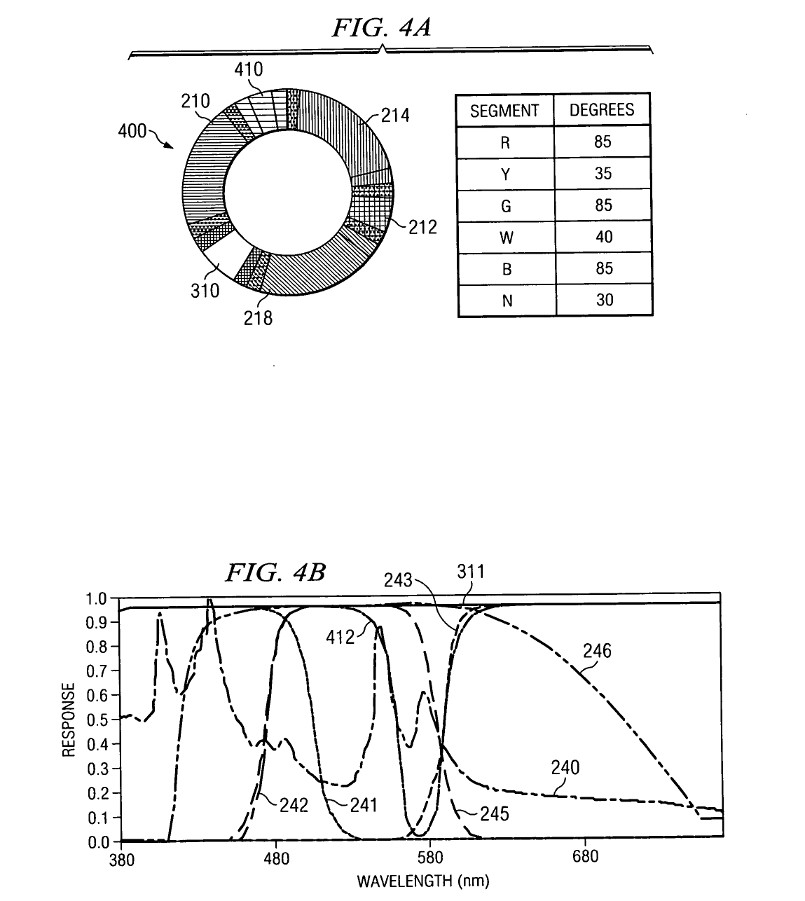

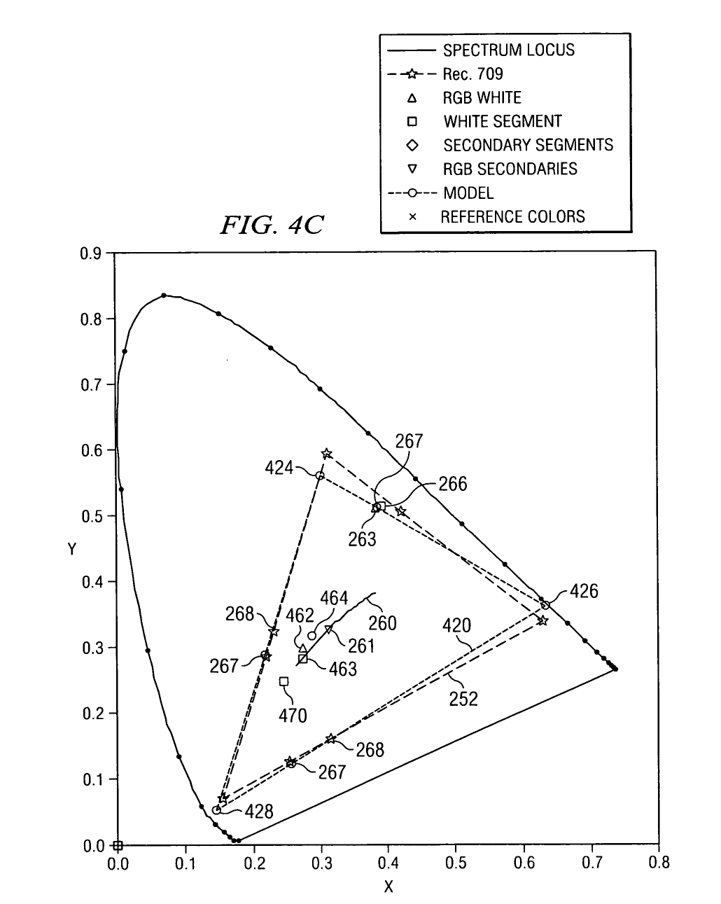

FIG. 4a is a plan view of yet another color filter wheel 400 in accordance with an embodiment of the present invention. Color filter wheel 400 is similar to the color filter wheel 300 illustrated in FIG. 3a wherein like reference numerals refer to like elements, except that a notch-filter segment 410 has replaced the mixed-transmission level segment 216 of the color filter wheel 300. In this embodiment, the blue segment 210 is about 85°, the yellow segment 212 is about 35°, the red segment 214 is about 85°, the notch-filter segment 410 is about 30°, the green segment 218 is about 85°, and the white segment 310 is about 40°. Other sizes and configurations may be used. In particular, it should be noted that the color filter wheel 400 illustrates a preferred embodiment comprising a yellow segment, but that other embodiments may not utilize a yellow segment and/or comprise additional segments, such as zero or more of each of a cyan segment, a magenta segment, a white segment, shades thereof, combinations thereof, and/or the like.

Generally, the notch-filter segment 410 substantially blocks a predetermined range of wavelengths, thereby preventing those wavelengths from passing through the color filter wheel 400. In an embodiment, the notch-filter segment 410 blocks wavelengths ranging from about 530 nm to about 600 nm from passing through the color filter wheel 400. This is illustrated in the spectral response graph of FIG. 4b, wherein line 412 is the spectral response for the notch-filter segment 410.

It should be noted that the wavelengths blocked by the notch-filter segment 410 are provided for illustrative purposes only and that other notch filters may be used. In particular, other embodiments may position the notch along the color spectrum at a different location and may widen (e.g., block more wavelengths) or narrow (e.g., block fewer wavelengths) its width.

FIG. 4c is a chromaticity graph corresponding to the color filter wheel 400 of FIG. 4a in accordance with an embodiment of the present invention. The chromaticity graph illustrates a color gamut 420 and a color gamut 252. The color gamut 420 represents the colors that may be obtained using the color filter wheel 400, whereas vertices 424, 426, and 428 represent the colors green, red, and blue, respectively. Point 462 represents the white light that may be obtained by combining the blue segment 210, the red segment 214, and the green segment 218 of the color filter wheel 400. Point 463 represents the white light that may be obtained by using the white segment 310 of the color filter wheel 400. Point 464 represents the white light and may be obtained by using all of those segments of the color filter wheel 400, and point 470 represents the white light that may be obtained by using the notch-filter segment 410 of the color filter wheel 400.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of forming an image, the method comprising:
transmitting a light through a color filter wheel thereby generating a filtered light, the color filter wheel having a blue segment, a red segment, a green segment, and a fourth segment, the fourth segment allowing at least some wavelengths of light corresponding to lower wavelengths of visible light and at least some wavelengths of light corresponding to higher wavelengths of visible light to pass and at least partially blocking some wavelengths of visible light; and
generating an image with the filtered light.

2. The method of claim 1, wherein the fourth segment comprises a mixed-transmission level segment.

3. The method of claim 2, wherein the fourth segment has a wavelength cut-off value of about 530 nm.

4. The method of claim 2, wherein the fourth segment has a reduction offset of about 10% to about 90%.

5. The method of claim 1, wherein the fourth segment comprises a notch-filter segment, the notch-filter segment allowing shorter and longer wavelengths to pass and blocking at least some intermediate wavelengths.

6. The method of claim 1, wherein the generating is performed by modulating the filtered light onto a viewing surface.

7. The method of claim 6, wherein the modulating is performed at least in part by a digital micromirror device (DMD).

8. The method of claim 1, further comprising one or more of a white segment, a yellow segment, a cyan segment, a magenta segment, or combinations thereof.

9. A projection system comprising:
a light source configured to emit a beam of light;
a color filter wheel positioned in a path of the beam, the color filter wheel having a red segment, a blue segment, a green segment, and a mixed-transmission level segment, the mixed-transmission level segment having a first region on a first side of a cut-off value and a second region on a second side of the cut-off value, the first region allowing corresponding wavelengths to pass and the second region partially allowing corresponding wavelengths to pass.

10. The projection system of claim 9, wherein the first region corresponds to a blue end of the color spectrum and the second region corresponds to a red end of the color spectrum.

11. The projection system of claim 9, wherein the second region has a reduction offset of about 10% to about 90%.

12. The projection system of claim 9, further comprising a modulator, the modulator receiving filtered light from the color filter wheel and modulating the filtered light onto a viewing surface.

13. The projection system of claim 10, wherein the modulator comprises at least in part a digital micromirror device (DMD).

14. The projection system of claim 9, wherein the cut-off value is about 530 nm.

15. The projection system of claim 9, further comprising one or more of a white segment, a yellow segment, a cyan segment, a magenta segment, or combinations thereof.

16. A projection system comprising:
a light source configured to emit a beam of light;
a color filter wheel positioned in a path of the beam, the color filter wheel having a red segment, a blue segment, a green segment, and a notch-filter segment, the notch-filter segment comprising a notch filter.

17. The projection system of claim 16, further comprising a modulator, the modulator receiving filtered light from the color filter wheel and modulating the filtered light onto a viewing surface.

18. The projection system of claim 17, wherein the modulator comprises a digital micromirror device (DMD).

19. The projection system of claim 16, further comprising one or more of a white segment, a yellow segment, a cyan segment, a magenta segment, or combinations thereof.

20. The projection system of claim 16, wherein the notch filter blocks at least some wavelengths between about 530 nm to about 600 nm.
